(19) United States
(12) Patent Application Publication
(10) Pub. No.: US 2026/0127880 A1
(43) Pub. Date: May 7, 2026

(54) KNOW-HOW PRESENTATION METHOD

(71) Applicant: TOYOTA JIDOSHA KABUSHIKI KAISHA, Toyota-shi (JP)

(72) Inventors: Masayuki OKAMOTO, Nagoya-shi (JP); Manabu OKUYAMA, Nisshin-shi (JP); Naoki YAMAMURO, Nagoya-shi (JP); Yasuomi TAKEUCHI, Toyota-shi (JP)

(73) Assignee: TOYOTA JIDOSHA KABUSHIKI KAISHA, Toyota-shi (JP)

(21) Appl. No.: 19/330,064

(22) Filed: Sep. 16, 2025

(30) Foreign Application Priority Data
Nov. 6, 2024 (JP) 2024-194743

(51) Int. Cl. G06V 20/40; G06F 16/783

(52) U.S. Cl. CPC G06V 20/42; G06F 16/783; G06V 20/49

(57) ABSTRACT

A know-how presentation method that is executed by an information processing device includes: acquiring text information related to an action including know-how, and first video information; identifying, from within the first video information, a video segment corresponding to the text information; and outputting the identified video segment in association with the text information.

### CROSS-REFERENCE TO RELATED APPLICATION

This application claims priority to Japanese Patent Application No. 2024-194743 filed on Nov. 6, 2024. The disclosure of the above-identified application, including the specification, drawings, and claims, is incorporated by reference herein in its entirety.

### BACKGROUND

### 1. Technical Field

The present disclosure relates to methods for presenting know-how including video information.

### 2. Description of Related Art

Conventionally, there has been disclosed a technique in which video data, audio data, and sensor data of a first user executing a task are acquired, and training information is generated from a domain model updated by processing the video data in association with the audio data and sensor data. The generated training information is then used to train a second user (see, for example, Japanese Unexamined Patent Application Publication No. 2021-099810 (JP 2021-099810 A)).

### SUMMARY

JP 2021-099810 A discloses that a machine learning system is applied to correlate video data with audio data and sensor data. However, the identification or presentation of a video corresponding to text information related to know-how is not addressed at all. In other words, there is room for improvement in techniques for presenting know-how. As used herein, “know-how” refers to specific or specialized knowledge, techniques, methods, and information that are typically conveyed through verbal explanations, images, actions, and the like. Examples of know-how include, but are not limited to, tasks such as screwing and assembly, operations of applications or software, and procedures for performing business tasks.

In view of the above circumstances, an object of the present disclosure is to improve techniques for presenting know-how.

A know-how presentation method according to an embodiment of the present disclosure is a know-how presentation method that is executed by an information processing device. The know-how presentation method includes:
acquiring text information related to an action including know-how, and first video information;
identifying, from within the first video information, a video segment corresponding to the text information; and
outputting the identified video segment in association with the text information.

According to one embodiment of the present disclosure, know-how presentation techniques are improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of an information processing device; and

FIG. 2 is a flowchart illustrating the operation of the information processing device.

### DETAILED DESCRIPTION OF EMBODIMENTS

An embodiment of the present disclosure will be described below.

### Overview of Embodiment

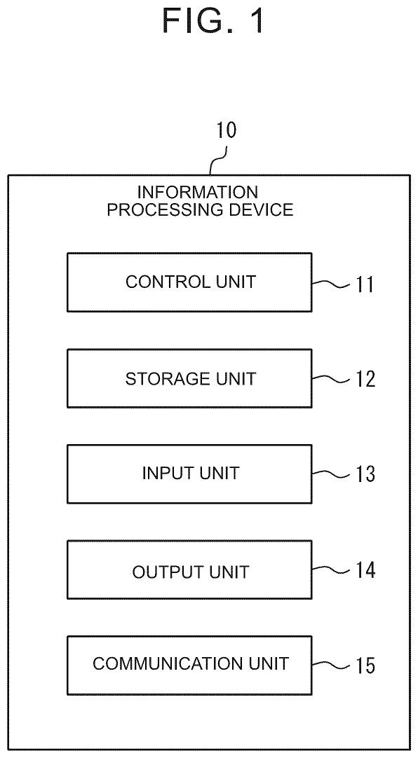

An overview and configuration of the present embodiment will be described with reference to FIG. 1.

The know-how presentation method according to the present embodiment is executed by an information processing device 10. The information processing device 10 may be any device that is used by each user. For example, general-purpose electronic devices such as personal computers, smartphones, tablet terminals, and wearable devices, or dedicated electronic devices, may be employed as the information processing device 10.

First, an overview of the present embodiment will be described, and details will be provided later. The information processing device 10 acquires text information related to an action including know-how, and first video information. The information processing device 10 identifies, from within the first video information, a video segment corresponding to the text information. The information processing device 10 then outputs the identified video segment in association with the text information.

As described above, according to the present embodiment, the information processing device 10 acquires text information related to an action and first video information, and outputs a video segment corresponding to the text information, in association with the text information. Therefore, the know-how presentation technique is improved in that text information related to an action and a video segment corresponding to the text information are associated with each other and presented together.

Next, the individual components of the information processing device 10 will be described in detail. As shown in FIG. 1, the information processing device 10 includes a control unit 11, a storage unit 12, an input unit 13, an output unit 14, and a communication unit 15. The control unit 11 includes at least one processor. The processor may be a general-purpose processor such as a central processing unit (CPU), or a dedicated processor specialized for specific processing. The control unit 11 controls each component of the information processing device 10 and executes processing related to the operation of the information processing device 10. The storage unit 12 includes at least one semiconductor memory or the like. The semiconductor memory is, for example, a random access memory (RAM) or a read-only memory (ROM). The storage unit 12 serves as, for example, a main storage device or an auxiliary storage device. The storage unit 12 stores data to be used in the operation of the information processing device 10 and data obtained through the operation of the information processing device 10. The input unit 13 includes at least one input interface. The input interface may be, for example, a physical key, a touchscreen, an audio sensor that accepts voice input, or a camera that accepts gesture input. The input unit 13 accepts input operations for inputting data used in the operation of the information processing device 10. The output unit 14 includes at least one output interface. The output interface may be, for example, a display that visually outputs information, or a speaker that audibly outputs information. The output unit 14 outputs data obtained through the operation of the information processing device 10. The communication unit 15 includes at least one external communication interface. The communication interface may be either a wired or wireless communication interface. In the case of wired communication, the communication interface may be, for example, a local area network (LAN) interface or a universal serial bus (USB) interface. In the case of wireless communication, the communication interface may be an interface that supports mobile communication standards such as 5G, or an interface that supports short-range wireless communication. The communication unit 15 receives data used in the operation of the information processing device 10 and transmits data obtained through the operation of the information processing device 10.

The functions of the information processing device 10 are implemented by executing a program according to the present embodiment using a processor corresponding to the control unit 11. That is, the functions of the information processing device 10 are implemented by software. The program causes a computer to perform the operations of the information processing device 10, thereby enabling the computer to function as the information processing device 10. In other words, the computer functions as the information processing device 10 by performing the operations of the information processing device 10 in accordance with the program. In the present embodiment, the program may be recorded on a computer-readable recording medium. The computer-readable recording medium includes a non-transitory computer-readable medium such as a magnetic storage device or a semiconductor memory. The program may be distributed, for example, by selling, transferring, or leasing a portable recording medium such as a digital versatile disc (DVD) on which the program is recorded. Alternatively, the program may be distributed by storing the program in the storage of an external server and transmitting the program from the external server to another computer. The program may also be provided as a program product. Part or all of the functions of the information processing device 10 may be implemented by a dedicated circuit corresponding to the control unit 11. That is, part or all of the functions of the information processing device 10 may be implemented by hardware.

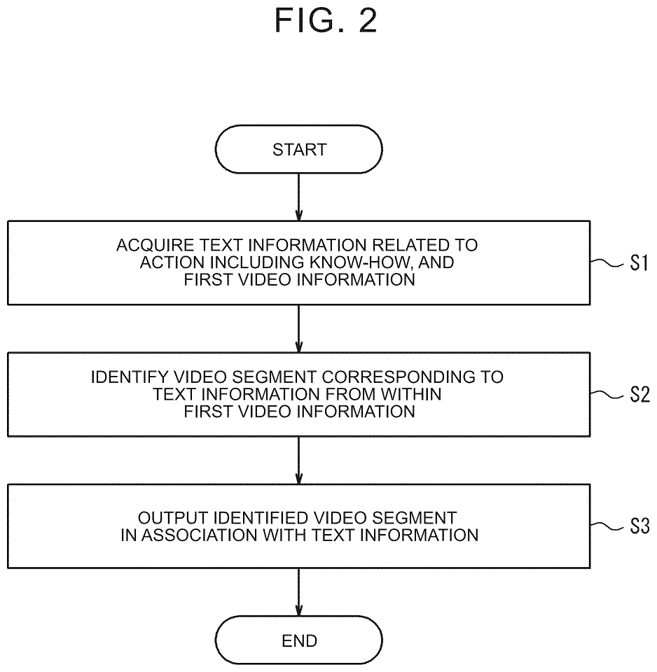

The operation of the information processing device 10 according to the present embodiment will be described with reference to FIG. 2. First, the control unit 11 of the information processing device 10 acquires text information related to an action including know-how, and first video information (step S1). Any method may be employed to acquire the text information related to the action and the first video information. For example, the control unit 11 may acquire the text information related to the action and the first video information via the input unit 13. Alternatively, the control unit 11 may acquire the text information related to the action and the first video information from an external device via the communication unit 15 and a network. The text information related to the action is text information regarding know-how. For example, the text information may represent know-how regarding an assembly task for a certain product (e.g., know-how regarding a method of performing hand movements during the assembly process). In this case, the first video information may be a video including a plurality of types of know-how related to the assembly task for the product (e.g., know-how regarding a method of performing hand movements during the assembly process and know-how regarding a method of performing foot movements during the assembly process). The action in the assembly task may be, for example, an operation involved in an assembly task for automobile manufacturing, such as engine component installation, door panel attachment, or tire mounting.

Next, the control unit 11 identifies, from within the first video information, a video segment corresponding to the text information (step S2). Any method may be employed to identify the video segment corresponding to the text information. For example, the control unit 11 may divide the first video information into a plurality of video segments based on audio content or movement of body parts in the first video information, and may identify the video segment based on the divided video segments and the text information. Alternatively, the control unit 11 may identify the video segment by extracting a portion of the video corresponding to the timing at which specific keywords appear in a spoken or textual explanation. More specifically, the control unit 11 may identify the video segment by detecting a scene change such as when the main acting body switches from hands to feet. For example, when the text information is about know-how regarding a method of performing hand movements in an assembly task for a certain product, the control unit 11 may identify a video segment that presents the know-how regarding the method of performing hand movements.

Next, the control unit 11 outputs the identified video segment in association with the text information (step S3). For example, the control unit 11 may output know-how in an adjusted form through a user interface via the output unit 14 of the information processing device 10. When the know-how is output based on the text information, the font size, font type, text color, background color, line spacing, or the like may be adjusted according to the level of priority of the know-how such that content with higher priority is displayed with emphasis. As used herein, the priority refers to a parameter that represents a numerical value or category that is comparable in magnitude, and is set in some manner when the know-how is acquired or input in advance. The priority may be set, for example, based on expert judgment, or in accordance with usage frequency, usage patterns, or the like. The identified video segment and the text information associated therewith may also be stored in a database or the like.

As described above, the information processing device 10 according to the present embodiment acquires text information related to an action including know-how, and first video information. The information processing device 10 identifies, from within the first video information, a video segment corresponding to the text information. The information processing device 10 then outputs the identified video segment in association with the text information.

With this configuration, the know-how presentation technique is improved in that text information related to an action and a video segment corresponding to the text information are associated with each other and presented together.

Although the present disclosure has been described with reference to the drawings and the embodiment, it should be understood that various modifications and alterations may be made based on the present disclosure by those skilled in the art. Such modifications and alterations are encompassed within the scope of the present disclosure. For example, the functions included in the components or steps may be rearranged as long as there is no logical inconsistency, and a plurality of components or steps may be combined into one, or may be individually divided into multiple sub-components or sub-steps.

For example, the above embodiment illustrates an example of presenting know-how related to an assembly task for a certain product. However, the present disclosure is not limited to this. The first video information may relate to any type of action such as actions associated with sports, dance, martial arts, or acting. For example, actions associated with sports may include a soccer shooting motion, a tennis serving motion, and a golf swing motion.

For example, the first video information may be a recording of an action performed by a first user. The first user may be an expert. The control unit 11 of the information processing device 10 may further include a step of acquiring, in real time, second video information of a second user. The second user may be any person. For example, the second user may be either a beginner or an expert. The control unit 11 may output, via the output unit 14 etc., a suggestion such as an alert based on a difference between the first video information and the second video information. This makes it possible to present the second user with information regarding the difference between the first video information and the second video information.

In the case where a suggestion is output, the timing of the notification of the suggestion may be adjusted based on the magnitude of the difference between the first video information and the second video information. For example, when the magnitude of the difference is greater than or equal to a threshold, the control unit 11 may immediately output the suggestion via the output unit 14 etc. This makes it possible to promptly notify the second user that the work procedure differs significantly, for example, in a case where the work procedure is completely different. On the other hand, when the magnitude of the difference is less than the threshold, the control unit 11 may output the suggestion via the output unit 14 etc. after a predetermined period of time. This makes it possible to reduce the frequency of notifications, for example, in a case where the work procedure does not differ significantly, thereby suppressing a reduction in work efficiency etc.

When outputting a suggestion, the control unit 11 may adjust the content of the suggestion based on attribute information of the second user. For example, when the skill level of the second user is less than a threshold, the control unit 11 may limit the content of the suggestion to items whose priority is greater than or equal to a threshold. Alternatively, when the skill level of the second user is greater than or equal to the threshold, the control unit 11 may increase the content of the suggestion.

When outputting a suggestion, the control unit 11 may adjust the content of the alert in accordance with the growth level of the second user based on the video history of the second user. For example, when the growth level of the second user is less than a threshold, the control unit 11 may limit the content of the suggestion to items whose priority is greater than or equal to a threshold. Alternatively, when the growth level of the second user is greater than or equal to the threshold, the control unit 11 may increase the content of the suggestion. The control unit 11 may output the growth level of the second user. The growth level may be calculated based on a score obtained from, for example, the amount of change, range of variation, or variance of the difference. For example, a decrease in the difference compared to one week earlier, or a decrease in the variance value of the difference indicating improved stability, may be output.

In the above embodiment, the configuration and operation of the information processing device 10 may be distributed among a plurality of computers capable of communicating with each other.

What is claimed is:

1. A know-how presentation method that is executed by an information processing device, the method comprising:
acquiring text information related to an action including know-how, and first video information;
identifying, from within the first video information, a video segment corresponding to the text information; and
outputting the video segment in association with the text information.

2. The know-how presentation method according to claim 1, wherein the first video information includes information on at least one of an action related to a work process, an action related to a sport, an action related to dance, an action related to a martial art, and an action related to acting.

3. The know-how presentation method according to claim 1, wherein the first video information is divided into a plurality of video segments based on audio content and movement of a body part in the first video information, and the video segment is identified based on the video segments and the text information.

4. The know-how presentation method according to claim 1, wherein:
the first video information is information obtained by capturing movement of a first user; and
the method further includes:
acquiring, in real time, second video information of a second user; and
presenting a suggestion based on a difference between the first video information and the second video information.

5. The know-how presentation method according to claim 4, wherein a timing of presenting the suggestion is adjusted based on a magnitude of the difference.
